(19) United States
(12) Patent Application Publication
(10) Pub. No.: US 2005/0225286 A1
(43) Pub. Date: Oct. 13, 2005

(54) Switch-charging apparatus

(76) Inventor: Man Ho Yang, Dongguan City (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/507,750

(22) PCT Filed: Mar. 7, 2003
(86) PCT No.: PCT/CN03/00175

§ 371 Date: Apr. 22, 2005

(30) Foreign Application Priority Data
Mar. 15, 2002 (CN) 02226208.3

(51) Int. Cl. H02J 7/00

(52) U.S. Cl. 320/114

(57) ABSTRACT

The present invention relates to a switch-charging apparatus of the chargeable electric torch which has a switch-charging base. A lug plate is placed in the middle of the switch-charging base between the bottom of the switch-case and the switch-charging base. A switch assembly matches with the upper of the lug plate while a charging assembly matches with the lower of the lug plate. The present invention provides a switch-charging apparatus of the chargeable electric torch with integrated charging and switch components, simple structure, and normally-open self-reset button function.

### TECHNICAL FIELD

The present invention relates to a switch-charging apparatus of the chargeable electric torch.

### RELATED ART

At present, in the common chargeable electric torches, the switch and the charging socket are completely independent components, and each of the charging socket and the switch occupy different spaces respectively, but with a lug plate connecting between them. When the switch is in operation, only if the sleeve with rib of the switch is connected with the input and output lug plates simultaneously, can the circuit be switched on. FIG. 1 shows schematically the structure of the most common button switch of a chargeable electric torch. The button switch composes a set of ratchet wheels 1 and a upper switch-case 2, a sleeve with rib 3, an input lug plate 4, a sleeve spring 5, a lower switch-case 6, an output lug plate 7. The circuit is off when the button is in the lower position, and the circuit is on when the circuit is in the upper position. The bulb can not be lightened if the button is not pressed to the right position. And the bulb can be switched off with a slight press on the button when the switch is in the ON position. The shortage of the prior art is that the switch and the charging socket occupy different spaces and two individual components are needed, which causes an increase of the number of the components and of the complication of the structure of the electric torch. The upper and lower positions of the switch button fail to meet people's habit of thinking and are not in conformity to the principles of human engineering. And the switch does not have a normally-open self-reset button function.

### SUMMARY OF THE INVENTION

The present invention is directed to solve the above-mentioned shortages of the prior art and provide a switch-charging apparatus of the chargeable electric torch with integrated charging and switch components, simple structure, and normally-open self-reset button function.

The objection of the present invention is realized by the following solution:

The switch-charging apparatus of the chargeable electric torch comprises a switch assembly and a charging assembly, which characterizes in that an inside lug plate is placed in the middle of the switch-charging base, the upper of which matches with a switch assembly, while the lower matches with a charging assembly.

The objection of the present invention can also be realized by the following solution:

The switch assembly comprises a ratchet wheel for translation which is on the top of the switch case, a ratchet wheel for rotation which is set in the ratchet wheel for translation, a sleeve with rib which is set in the ratchet wheel for rotation, a sleeve spring which is set in the sleeve with rib, a supporting spring which is set between the outside of the sleeve with rib and the bottom of the ratchet wheel for translation, and the lug plate between the bottom of the switch case and the switch-charging base.

The charging assembly comprises a copper ring which is set in the switch-charging base and with its top placed in the opening of the lug plate and below the lower end of the sleeve with rib, a conducting strip which is set in the switch-charging base and connected to the lower opening of the copper ring, an inserting pin which is at the lower of the conducting strip, a plug matching with the inserting pin, an anode of the plug connecting the insert pin with the hole of the plug, an elastic cathode pad connecting the outer circumference of the plug to the bottom of the switch-charging base.

The copper ring, the conducting strip below the copper ring, and the inserting pin in the through holes of the copper ring and the conducting strip are integrated into a whole body as an embedded parts of the switch-charging base and are formed by injection moulding.

The sleeve spring is longer and with a smaller stiffness coefficient, while the supporting spring is shorter and with a larger stiffness coefficient.

Compared with the prior art, the present invention has the following advantages:

The switch-charging apparatus of the chargeable electric torch according to the present invention has simple and optimized structure, reliable functions, low cost and good durability.

### BRIEF DESCRIPTION OF THE DRAWINGS

FIG. 1 shows schematically the structure of the most common button switch of a chargeable electric torch.

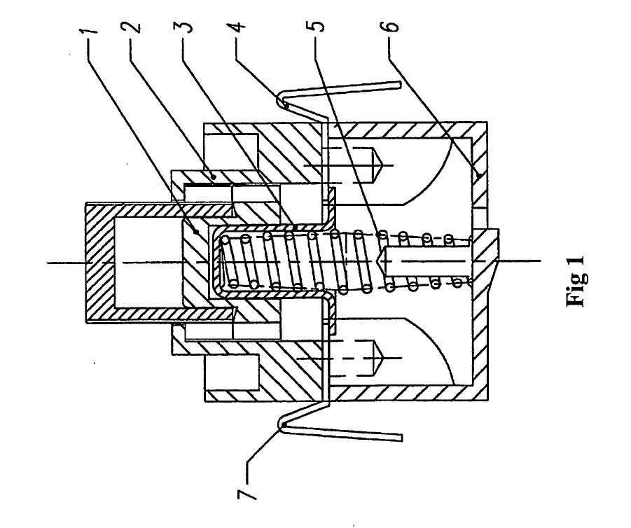

FIG. 2 shows schematically the sectional structure of the switch-charging switch according to the present invention.

FIG. 3 shows schematically the structure of the integrated embedded part of the switch-charging charging base according to the present invention.

FIG. 4 shows schematically the structure of the switch-charging apparatus when the switch is ON according to the present invention.

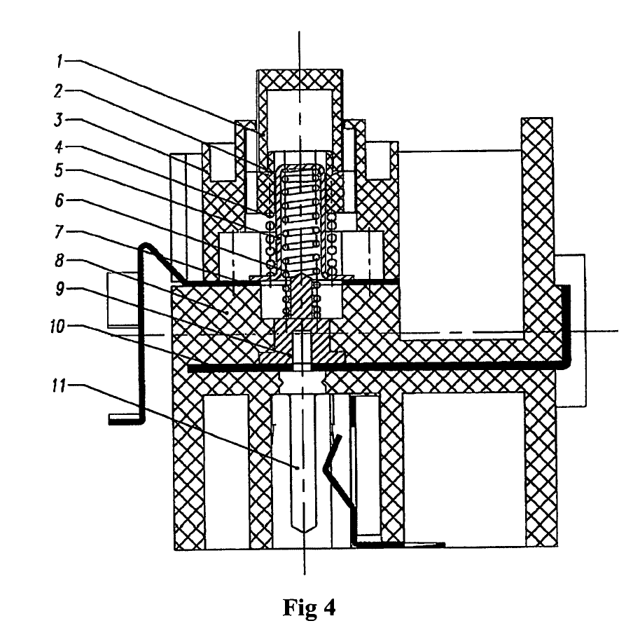

FIG. 5 shows schematically the position of the switch-charging apparatus according to the present invention in the chargeable electric torch.

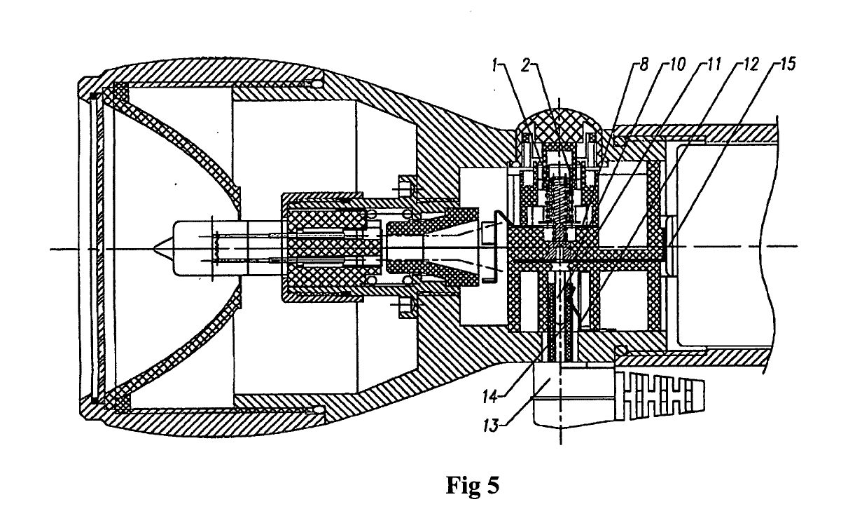

### DETAILED DESCRIPTION OF THE INVENTION

The detailed description of the present invention will now be made with reference to the accompanying drawings.

The construction of the switch-charging apparatus of the chargeable electric torch is described as the following:

Such a switch-charging apparatus related to the chargeable electric torch comprises a switch assembly and a charging assembly, an inside lug plate 7 being placed in the middle of the switch-charging base 8, with the upper of the lug plate 7 matches with a switch assembly, while the lower matches with a charging assembly. The switch assembly comprises a ratchet wheel for translation 1 which is on the top of the switch case 3, a ratchet wheel for rotation 2 which is set in the ratchet wheel for translation 1, a sleeve with rib 5 which is set in the ratchet wheel for rotation 2, a sleeve spring 6 which is set in the sleeve with rib 5, a supporting spring 4 which is set between the outside of the sleeve with rib 5 and the bottom of the ratchet wheel for translation 1, and the lug plate 7 between the bottom of the switch case 3 and the switch-charging base 8. The charging assembly comprises a copper ring 9 which is set in the switch-charging base 8 and with its top placed in the opening of the lug plate 7 and below the lower end of the sleeve with rib 5, a conducting strip 10 which is set in the switch-charging base 8 and connected to the lower opening of the copper ring 9, an inserting pin 11 which is at the lower of the conducting strip 10, a plug 13 matching with the inserting pin 11, an anode 14 of the plug connecting the insert pin 11 with the hole of the plug 13, an elastic cathode pad 12 connecting the outer circumference of the plug 13 to the bottom of the switch-charging base 8. The copper ring 9, the conducting strip 10 below the copper ring, and the inserting pin 11 set in the through holes of the copper ring 9 and the conducting strip 10 are integrated into a whole body as an embedded part of the switch-charging base 8 and are formed by injection moulding. The sleeve spring 6 is longer and with a smaller stiffness coefficient, while the supporting spring 4 is shorter and with a larger stiffness coefficient.

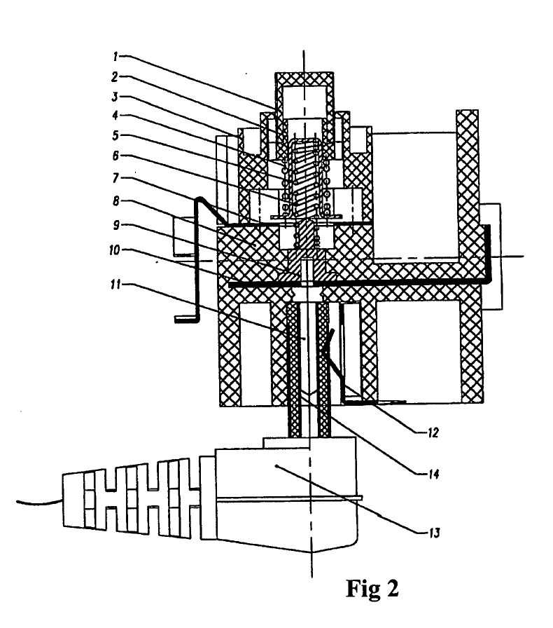

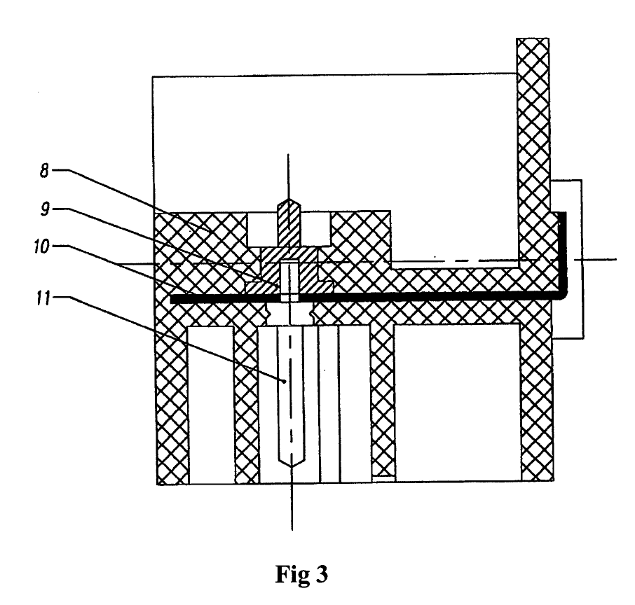

During charging, the anode 14 of the plug of the charger is connected to the inserting pin 11, and the current flows through the inserting pin 11, the conducting strip 10 and into the anode 15 of the chargeable cell, and after out of the cathode, the current flows through the body of the torch, the elastic cathode pad 12 to connect to the cathode of the charger, so that a charging circuit is formed to charge the chargeable cell. As a part, the switch is installed above the switch-charging base 8 with the inserting pin 11 of the charging part connecting to the copper ring 9, the sleeve spring 6 and the sleeve with rib 5. The ratchet wheel for rotation 2 has an upper position and a lower position inside the switch. When the ratchet wheel for translation 2 is in the upper position, the support spring 4 is less compressed, and the sleeve with rib 5 is not connected to the lug plate 7 under the action of the sleeve spring 6, so the switch is in off state, as shown in FIG. 2. After the switch being pressed down, the ratchet wheel for rotation 2 passes the highest point and sits in the lower position, as shown in FIG. 3, then the supporting spring 4 is in the more pressed state, and because the supporting spring 4 has a larger stiffness coefficient K than that of the sleeve spring 6, the sleeve with rib 5 moves down under the action of the supporting spring 4 to connect to and press the lug plate 7 to set the switch on. If the switch button is pressed down again, the switch will be off. If the switch is pressed while the ratchet wheel for rotation 2 has not passed the highest point of the tooth shape, the ratchet wheel for rotation 2 will move down to allow the sleeve with rib 5 connecting to the lug plate 7. However, the ratchet wheel for rotation 2 can reset at this time and the switch will be off when the button is released.

### INDUSTRIAL APPLICABILITY

The switch-charging apparatus of the present invention has overcome the shortages of the prior art. The apparatus integrates the charging and the switch components into a whole body and is provided with normally-open self-reset button function, with simple and optimized structure, and reliable functions.

1. A switch-charging apparatus of a chargeable electric torch, comprising:
a switch assembly, a charging assembly and an inside lug plate that is placed in the middle of the switch-charging base, where an upper portion matches with the switch assembly, while a lower portion matches with the charging assembly.

2. The switch-charging apparatus as set forth in claim 1, further comprising the switch assembly with a first ratchet wheel for translation which is on a top portion of a switch case, a second ratchet wheel for rotation which is set in the first ratchet wheel for translation, a sleeve with a rib which is set in the second ratchet wheel for rotation, a sleeve spring which is set in the sleeve with the rib, a supporting spring which is set between an outside portion of the sleeve with the rib and a bottom portion of the first ratchet wheel for translation, and the lug plate between the bottom of the switch case and the switch-charging base.

3. The switch-charging apparatus as set forth in claim 1, further comprising the charging assembly with a copper ring which is set in the switch-charging base with its top placed in an opening of the lug plate and below a lower end of the sleeve with the rib, a conducting strip which is set in the switch-charging base and connected to a lower opening of the copper ring, an inserting pin which is at the lower of the conducting strip, a plug matching with the inserting pin, an anode of the plug connecting the inserting pin with a hole of the plug, an elastic cathode pad connecting the outer circumference of the plug to the bottom of the switch-charging base.

4. The switch-charging apparatus as set forth in claim 1, further comprising the copper ring, the conducting strip below the copper ring, and the inserting pin set in the holes of the copper ring and the conducting strip are integrated into a whole body as an embedded part of the switch-charging base and are formed by injection molding.

5. The switch-charging apparatus as set forth in claim 1, further comprising the sleeve spring is longer and has a smaller stiffness coefficient, while the supporting spring is shorter with a larger stiffness coefficient.

6. The switch-charging apparatus as set forth in claim 3, further comprising the copper ring, the conducting strip below the copper ring, and the inserting pin set in the holes of the copper ring and the conducting strip are integrated into a whole body as an embedded part of the switch-charging base and are formed by injection molding.

7. The switch-charging apparatus as set forth in claim 2, further comprising the sleeve spring is longer and has a smaller stiffness coefficient, while the supporting spring is shorter with a larger stiffness coefficient.

8. A switch-charging apparatus of a chargeable electric torch comprising:
the switch assembly and the charging assembly which are arranged up and down, wherein the switch assembly has the switch case, the ratchet wheel for translation which is on the top of the switch case, the ratchet wheel for rotation which is set in the ratchet wheel for translation, the sleeve which is set in the ratchet wheel for rotation, the sleeve spring which is set in the sleeve, the supporting spring which is set outside the sleeve, and the lug plate set at the bottom of the switch case.

9. The charging assembly as set forth in claim 8, further comprising the switch-charging base, the copper ring which is set in the switch-charging base and under the sleeve, the conducting strip which is set in the switch-charging base and connected to the lower end of the copper ring, the inserting pin for connecting to the anode of the plug and the elastic cathode pad for connecting to the cathode of the plug.

10. The switch-charging apparatus as set forth in claim 8, further comprising the copper ring, the conducting strip, and the inserting pin are formed integrally as an embedded part of the switch-charging base by injection molding.

11. The switch-charging apparatus as set forth in claim 8, further comprising the sleeve spring is longer and with a smaller stiffness coefficient, while the supporting spring is shorter and with a larger stiffness coefficient.

12. The switch-charging apparatus as set forth in claim 9, further comprising the sleeve spring is longer and with a smaller stiffness coefficient, while the supporting spring is shorter and with a larger stiffness coefficient.

13. The switch-charging apparatus as set forth in claim 10, further comprising the sleeve spring is longer and with a smaller stiffness coefficient, while the supporting spring is shorter and with a larger stiffness coefficient.
